(19) United States
(12) Patent Application Publication
(10) Pub. No.: US 2018/0216571 A1
(43) Pub. Date: Aug. 2, 2018

(54) VENT NOZZLE SHOCKWAVE CANCELLATION

(71) Applicant: General Electric Company, Schenectady, NY (US)

(72) Inventor: Tomasz IGLEWSKI, Warsaw (PL)

(21) Appl. No.: 15/850,786

(22) Filed: Dec. 21, 2017

(30) Foreign Application Priority Data
Jan. 30, 2017 (PL) P-420340

(51) Int. Cl. F02K 1/46

(52) U.S. Cl. CPC F02K 1/46; F05D 2250/711; F05D 2220/32; F05D 2250/75; F05D 2240/128; F05D 2250/712

(57) ABSTRACT

A vent nozzle configured to minimize adverse flow interactions between merging gas flows that have two different speeds. The nozzle includes a first wall that defines an outer surface and an inner surface. A first flowpath is positioned on one side of the first wall such that the first flowpath is adjacent to the outer surface. A second flowpath is positioned on another side of the first wall such that the second flowpath is adjacent to the inner surface. A second wall is spaced-apart from the first wall and that defines a portion of the second flowpath and an extension of the second wall extends beyond the first wall. The extension of the second wall approaches an imaginary line that is defined by an extension of the outer surface.

### BACKGROUND OF THE INVENTION

The present invention relates to gas turbine engines and more specifically to nozzles used in turbomachinery.

A gas turbine engine includes, in serial flow communication, a compressor, a combustor, and a turbine. The turbine is mechanically coupled to the compressor and the three components define a turbomachinery core. The core is operable to generate a flow of hot, pressurized combustion gases. The core forms the basis for several aircraft engine types such as turbojets, turboprops, and turbofans.

In most turbofan engines there is a fan duct that is configured to exhaust a supersonic gas stream, or flow, across an aft vent nozzle. The aft vent is configured to exhaust a subsonic gas flow into the supersonic gas stream. Two flow phenomena that can occur as the two streams merge are Prandtl-Meyer expansion fans and shockwaves.

Regarding Prandtl-Meyer expansion fans, conventional aft vent nozzles are configured as an aft-facing step or as a simple hole in the wall adjacent to the region where supersonic flow occurs. When such a vent is configured as an aft facing step, the subsonic flow from the vent is accelerated by viscosity of the fluid. The acceleration reduces the cross-section of the subsonic flow thus providing space for the supersonic flow to expand. In this way, space is provided for Prandtl-Meyer expansion bands to occur. Regarding shockwaves, additional flow can cause discrete changes in supersonic flow direction which results in a shockwave. Both phenomena increase flow entropy and cause aerodynamic loss. Therefore there is a need for an aft facing vent in turbomachinery that is configured to provide less interference and associated aerodynamic losses when a low-speed gas stream is introduced into a supersonic stream.

### BRIEF DESCRIPTION OF THE INVENTION

This need is addressed by a secondary flow path that includes a wall extension that is configured to reduce the cross-section of the secondary flow path to correspond with acceleration of gases within the flowpath.

According to one aspect of the present invention, there is provided a vent nozzle configured to minimize adverse flow interactions between merging gas flows that have two different speeds. The nozzle includes a first wall that defines an outer surface and an inner surface. A first flowpath is positioned on one side of the first wall such that the first flowpath is adjacent to the outer surface. A second flowpath is positioned on another side of the first wall such that the second flowpath is adjacent to the inner surface. A second wall is spaced-apart from the first wall and defines a portion of the second flowpath. An extension of the second wall extends beyond the first wall. The extension of the second wall approaches an imaginary line that is defined by an extension of the outer surface.

According to another aspect of the present invention there is provided a method for merging a subsonic gas flow with a supersonic gas flow such that adverse flow effects are minimized. The method includes the steps of: contacting the supersonic flow with the subsonic flow; accelerating the subsonic flow; and diverting the subsonic flow toward the supersonic flow as the subsonic flow is accelerated.

### BRIEF DESCRIPTION OF THE DRAWINGS

The invention may be best understood by reference to the following description taken in conjunction with the accompanying drawing figures in which:

FIG. 1 is an enlarged partially cutaway schematic view of a turbofan engine;

FIG. 2 is a cutaway sectional view of a portion of a turbofan engine showing the contoured surface of an aft vent;

FIG. 3 is a schematic view of the profile of an aft vent;

FIG. 4 is a schematic view of the profile of another aft vent;

FIG. 5 is a schematic view of the profile of another aft vent;

FIG. 6 is a schematic view of the profile of another aft vent;

FIG. 7 is a schematic view of the profile of another aft vent; and

FIG. 8 is a schematic view of the profile of another aft vent.

### DETAILED DESCRIPTION OF THE INVENTION

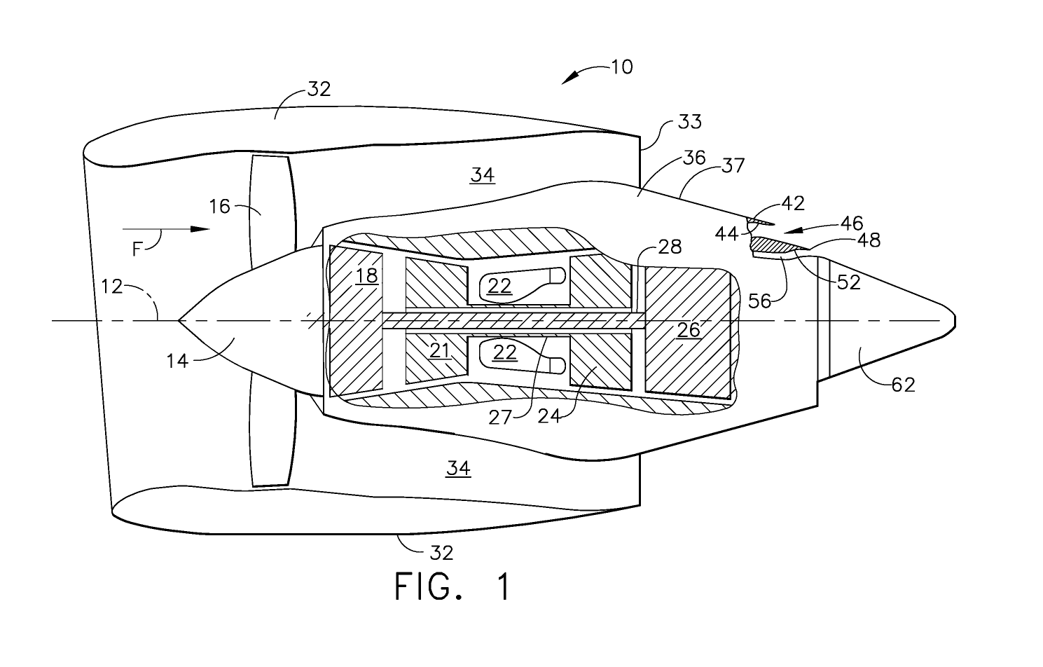

Referring to the drawings wherein identical reference numerals denote the same elements throughout the various views, FIG. 1 depicts an exemplary gas turbine engine 10. While the illustrated example is a high-bypass turbofan engine, the principles of the present invention are also applicable to other types of engines, such as low-bypass turbofans, turbojets, turboprops, etc.

The engine 10 has a longitudinal center line or axis 12. As used herein, the terms “axial” and “longitudinal” both refer to a direction parallel to the centerline axis 12, while “radial” refers to a direction perpendicular to the axial direction, and “tangential” or “circumferential” refers to a direction mutually perpendicular to the axial and tangential directions. As used herein, the terms “forward” or “front” refer to a location relatively upstream in an air flow passing through or around a component, and the terms “aft” or “rear” refer to a location relatively downstream in an air flow passing through or around a component. The direction of this flow is shown by the arrow “F” in FIG. 1. These directional terms are used merely for convenience in description and do not require a particular orientation of the structures described thereby.

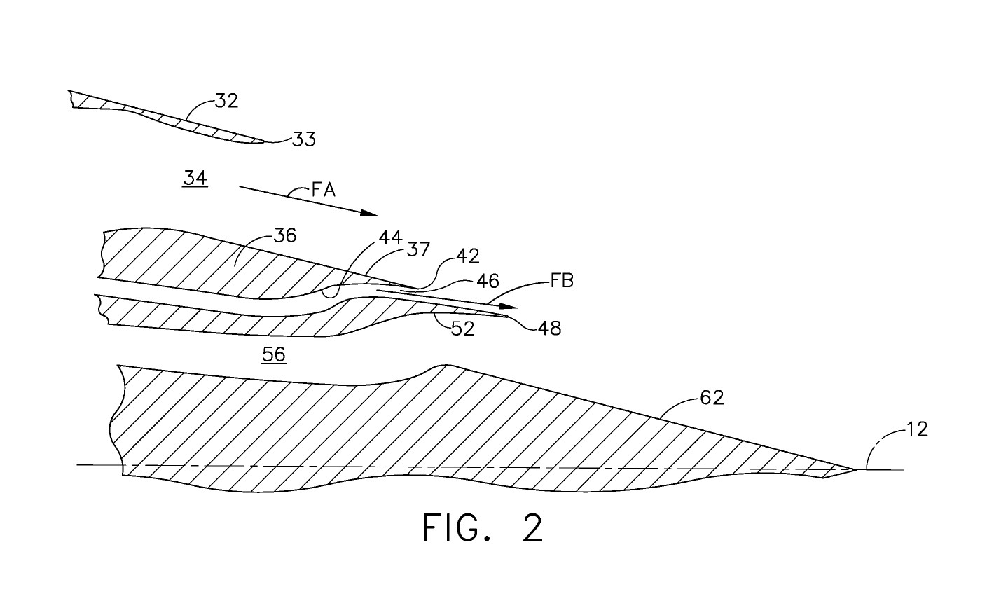

Referring now to FIGS. 1 and 2, the engine 10 includes a fan nacelle 32 that is disposed concentrically about and coaxially along the axis 12. The fan nacelle 32 is configured to house a core nacelle cowling 36 such that core nacelle cowling 36 and the fan nacelle 32 share the axis 12. A fan 16 is positioned within the fan nacelle 32 such that it is forward of the core nacelle cowling 36. A booster 18, a compressor 21, a combustor 22, a high pressure turbine 24, and a low pressure turbine 26 are positioned within the core nacelle cowling 36. The fan 16, the booster 18, the compressor 21, the combustor 22, the high pressure turbine 24, and the low pressure turbine 26 are arranged in serial flow relationship.

Referring now to flow paths, the engine 10 includes a core exhaust 56, a fan duct 34, and a secondary flow path 46. The core exhaust 56 is defined between the secondary flow path 46 and the axis 12. And it should be appreciated that the engine 10 can include additional flow paths beyond those described herein.

The fan duct 34 is defined between the fan nacelle 32 and the core nacelle cowling 36 such that it extends from the fan 16 to an aft trailing edge 33 of the fan nacelle 32. The core nacelle cowling 36 includes a core nacelle cowling shell 42 that defines an outer surface 37 positioned aft of the trailing edge 33. The core nacelle cowling shell 42 also defines in part a secondary flow path 46. The secondary flow path 46 extends from, and is fluidly connected to, a plurality of sources within the core 36. The secondary flow path 46 is also fluidly connected to the outer surface 37 near the core nacelle cowling edge 48. It should be appreciated that the secondary flow path 46 is configured as a vent.

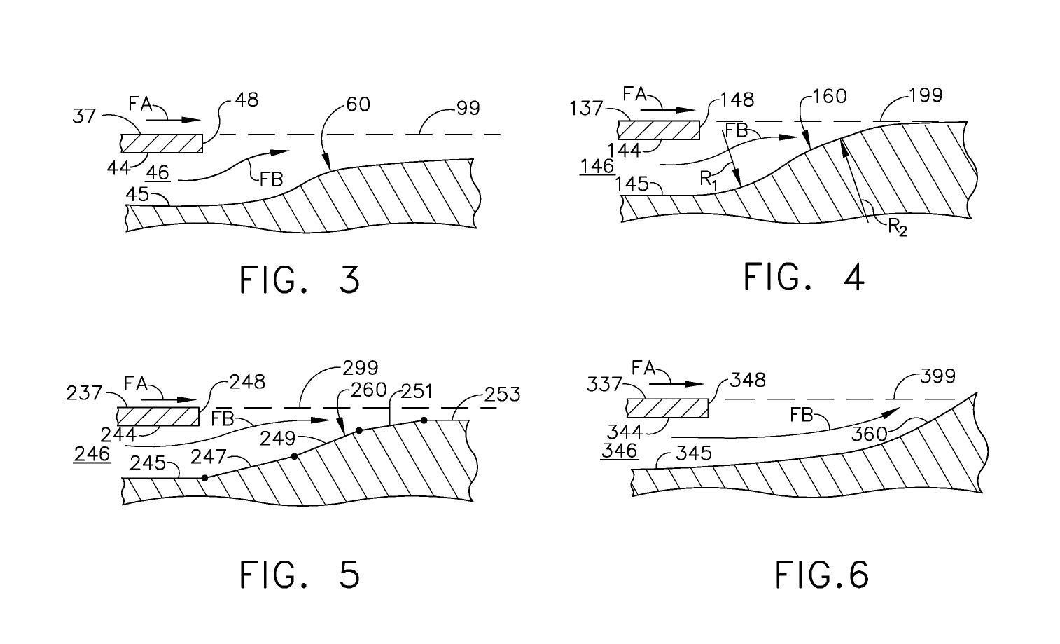

As can be seen in FIG. 3, the secondary flow path 46 is defined at least in part by an upper wall 44, a lower wall 45, and a lower wall extension 60. The upper wall 44 and the lower wall 45 extend aft to a point axially aligned with the core nacelle cowling edge 48. The upper wall 44 and the lower wall 45 are spaced-apart as they approach the core nacelle cowling edge 48. The lower wall extension 60 begins at a point axially aligned with the cowl edge 48 and extends aft from the lower wall 45. The lower wall extension 60 is configured to approach an imaginary line 99 that is defined as an extension of the outer surface 37. The profile of the lower wall extension 60 is a simple s-shape. It should be appreciated that in other embodiments the profile of the lower wall extension 60 can be any other geometric shapes suitable to accelerate flow in the secondary flow path 46 as described below.

The present invention can be better understood from a description of the operation thereof. Referring initially to the general operation of the engine 10, pressurized air from the compressor 21 is mixed with fuel in the combustor 22 and ignited, thereby generating combustion gases. Some work is extracted from these gases by the high pressure turbine 24 which drives the compressor 21 via an outer shaft 27. The combustion gases then flow into the low pressure turbine 26, which drives the fan 16 and the booster 18 via an inner shaft 28.

The combustion gases are exhausted through the core exhaust 56. Gases from the fan 16 travel through the fan duct 34 at a subsonic speed prior to being exhausted as a gas flow FA. As it exits from the fan duct 34 at the aft trailing edge 33, the gas flow FA expands and accelerates to supersonic speeds. As can be seen in FIG. 2 and FIG. 3, the gas flow FA travels adjacent to the surface 37 and then passes aft of the core nacelle cowling edge 48. It is at this location immediately aft of edge 48 that a gas flow FB from the secondary flow path 46 can interact with the gas flow FA. It should be appreciated that the gas flow FB extends from the lower wall 45 to the upper wall 44 and is traveling at subsonic speeds as it exits the secondary flow path 46.

The present invention provides a method for combining the supersonic gas flow FA with the subsonic gas flow FB such that adverse flow effects such as Prandtl-Meyer expansion fans and shockwaves are minimized. After exiting the secondary flow path 46, the gas flow FB contacts the adjacent supersonic gas flow FA and as a result the gas flow FB is accelerated. As a result the cross-section of the gas flow FB is reduced.

As the gas flow FB flows along the lower wall extension 60, gas flow FB is diverted toward the line 99 by lower wall 60. In this regard, the lower wall extension 60 is configured to approach the imaginary line 99 such that the intersection between the gas flows FA and FB remains generally in the area of the imaginary line 99. As a result, the gas stream FA is not subjected to expansion and the corresponding Prandtl-Meyer expansion fans.

Also, the gas flow FB is guided by lower wall extension 60 such that the gas flow FB generally fills the space between the lower wall extension 60 and the line 99 but does not abruptly cross the line 99. In this manner, abrupt introduction of the gas flow FB into the gas flow FA is avoided and shockwaves are not created.

Referring now to FIGS. 4-8, alternative embodiments to the present invention are shown in those figures and described further below. It is noted that each alternative embodiment is described using reference numbers in a given 100 series. Similar reference numbers in different 100 series refer to similar parts disclosed in the embodiment described above and/or another alternative embodiment.

FIG. 4 shows an alternative embodiment of the present invention that includes a core outer surface 137 and a secondary flow path 146. The secondary flow path 146 is defined by an upper wall 144, a lower wall 145, and a lower wall extension 160. The upper wall 144 and the lower wall 145 each extend to a points axially aligned with a core nacelle cowling edge 148. The upper wall 144 and the lower wall 145 are spaced apart and generally parallel near the core nacelle cowling edge 148. The lower wall extension 160 extends aft from the lower wall 145. The lower wall extension 160 is configured to approach an imaginary line 199 that is defined as an extension of the outer surface 137. The profile of the lower wall extension 160 is defined by a first curve having a radius R1 and an opposing second curve having a radius R2.

FIG. 5 shows an alternative embodiment of the present invention that includes a core outer surface 237 and a secondary flow path 246. The secondary flow path 246 is defined by an upper wall 244, a lower wall 245, and a lower wall extension 260. The upper wall 244 and the lower wall 245 each extend to points axially aligned with a core nacelle cowling edge 248. The upper wall 244 and the lower wall 245 are spaced apart and generally parallel near the core nacelle cowling edge 248. The lower wall extension 260 extends aft from the lower wall 245. The lower wall extension 260 is configured to approach an imaginary line 299 that is defined as an extension of the outer surface 237. The profile of the lower wall extension 260 is defined by multiple line segments 247, 249, 251, and 253.

FIG. 6 shows an alternative embodiment of the present invention that includes a core outer surface 337 and a secondary flow path 346. The secondary flow path 346 is defined by an upper wall 344, a lower wall 345, and a lower wall extension 360. The upper wall 344 and the lower wall 345 each extend to points axially aligned with a core nacelle cowling edge 348. The upper wall 344 and the lower wall 345 are spaced apart and generally parallel near the core nacelle cowling edge 348. The lower wall extension 360 extends aft from the lower wall 345. The lower wall extension 360 is configured to approach an imaginary line 399 that is defined as an extension of the outer surface 337. The profile of the lower wall extension 360 is concave relative to the line 399.

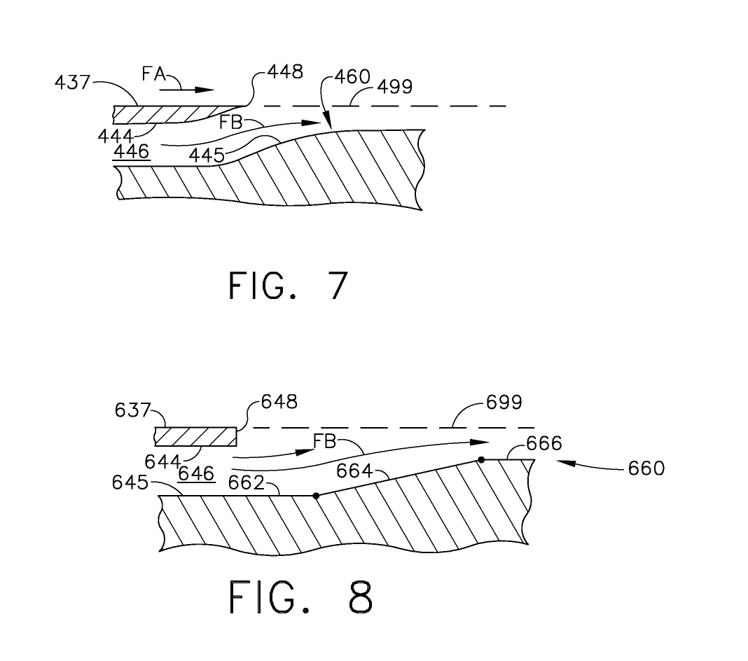

FIG. 7 shows an alternative embodiment of the present invention that includes a core outer surface 437 and a secondary flow path 446. The secondary flow path 446 is defined by an upper wall 444, a lower wall 445, and a lower wall extension 460. The upper wall 444 and the lower wall 445 curve upward such that the upper wall 444 intersects the surface 437 at the core nacelle cowling edge 448. The upper wall 444 and the lower wall 445 are spaced apart and generally parallel near the core nacelle cowling edge 448. The lower wall 445 continues aft of the edge 448 to define a simple S shape. The lower wall extension 460 is configured to approach an imaginary line 499 that is defined as an extension of the outer surface 437.

FIG. 8 shows an alternative embodiment of the present invention that includes a core outer surface 637 and a secondary flow path 646. The secondary flow path 646 is defined by an upper wall 644, a lower wall 645, and a lower wall extension 660. The upper wall 644 and the lower wall 645 extend to a point axially aligned with a core nacelle cowling edge 648. The upper wall 644 and the lower wall 645 are spaced apart and generally parallel near the core nacelle cowling edge 648. The lower wall extension 660 extends aft from the lower wall 645. The lower wall extension 660 is configured to approach an imaginary line 699 that is defined as an extension of the outer surface 637. The profile of the lower wall extension 660 is defined as a line segment ramp 664 is separated from the lower wall 645 by a first line segment 662 that is parallel to the imaginary line 699. A second line segment 666 extends from the ramp 664 such that line segment 666 is parallel to the imaginary line 699 and is spaced apart from the first line segment 662 by the ramp 664.

The gas turbine engine having an intersection of a gas stream at a fan duct exit traveling at supersonic speeds and a subsonic gas stream described herein has advantages over the prior art. In particular, the wall of the secondary flowpath is defined such that it approaches imaginary line extending from an adjacent surface of the fan duct reduces flow patterns that can exist near the core nacelle cowling edge of the engine 10. These flow patterns include Prandtl-Meyer expansion fans and oblique shocks and reducing them can improve specific fuel consumption of the engine.

The foregoing has described a structure and a method for reducing vent shockwaves in a gas turbine engine. All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

What is claimed is:

1. A vent nozzle configured to minimize adverse flow interactions between merging gas flows that have two different speeds, the nozzle comprising:
a first wall that defines an outer surface and an inner surface;
a first flowpath positioned on one side of the first wall such that the first flowpath is adjacent to the outer surface;
a second flowpath positioned on another side of the first wall such that the second flowpath is adjacent to the inner surface;
a second wall that is spaced-apart from the first wall and that defines a portion of the second flowpath;
an extension of the second wall extends beyond the first wall; and
wherein the extension of the second wall approaches an imaginary line that is defined by an extension of the outer surface.

2. The vent nozzle according to claim 1, wherein the first wall is substantially parallel to the outer surface.

3. The vent nozzle according to claim 2, wherein a first portion of the second wall is parallel to the inner surface.

4. The nozzle according to claim 1, wherein the extension of the second wall begins at a first location and ends at a second location that is closer to the imaginary line than the first location.

5. The nozzle according to claim 4, wherein the extension of the second wall includes a third location positioned between first and second locations and the third location is closer to the imaginary line than the second location.

6. The nozzle according to claim 4, wherein the extension of the second wall is concave.

7. The nozzle according to claim 4, wherein the extension of the second wall is convex.

8. The nozzle according to claim 4, wherein the extension is configured as a ramp that is configured to divert the flowpath toward the imaginary line.

9. The nozzle according to claim 4, wherein the extension is s-shaped.

10. A gas turbine engine configured to reduce detrimental flow effects, the engine comprising:
a core nacelle cowling that defines an outer surface;
a fan duct defined outside of the core nacelle cowling that is configured to discharge a first gas flow that accelerates to a supersonic speed across the outer surface;
a core exhaust positioned within the core nacelle cowling radially between an axis of the engine and the fan duct;
a secondary flowpath configured to exhaust a second gas stream and that is positioned within the core nacelle cowling radially between the core exhaust and the fan duct and that is fluidly connected to the outer surface; and
wherein the secondary flowpath is defined in part by a first wall that extends aft to an end and a second wall that is positioned between the first wall and the core exhaust and that extends aft beyond the end of the first wall toward an imaginary extension of the outer surface from a first point that is spaced-away from the imaginary extension to a second point that is closer to the imaginary extension.

11. The engine according to claim 10, wherein the second wall includes a portion that is substantially parallel to the outer surface.

12. The engine according to claim 10, wherein the second wall includes a third point positioned between first and second points and the third point is closer to the imaginary extension than the second point.

13. The engine according to claim 10, wherein the profile of the second wall aft of the first wall is concave.

14. The engine according to claim 10, wherein the profile of the second wall aft of the first wall is convex.

15. The engine according to claim 10, wherein a portion of the second wall aft of the first wall is defined as a ramp that is configured to divert the secondary flowpath toward the imaginary extension of the outer surface.

16. The engine according to claim 10, wherein the profile of the second wall aft of the first wall is s-shaped.

17. A method for merging a subsonic gas flow with a supersonic gas flow such that adverse flow effects are minimized, the method comprising the steps of:
contacting the supersonic flow with the subsonic flow;
accelerating the subsonic flow;
diverting the subsonic flow toward the supersonic flow as the subsonic flow is accelerated.

18. The method according to claim 17, further including the step of:
reducing the cross-section of the subsonic gas flow.

19. The method according to claim 18, further including the step of:
guiding the subsonic flow such that is continues generally parallel with the supersonic flow.

20. The method according the claim 19, further including the step of:
preventing Prandtl-Meyer expansion fans and shock waves.
